(19) United States
(12) Patent Application Publication
(10) Pub. No.: US 2007/0215685 A1
(43) Pub. Date: Sep. 20, 2007

(54) System and Method of Product Identification Using a URL

(75) Inventors: Matthew SELF, Emerald Hills, CA (US); Elliott GRANT, Redwood City, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: YOTTAMARK, INC., Redwood City, CA (US)

(21) Appl. No.: 11/743,652

(22) Filed: May 2, 2007

Related U.S. Application Data
(63) Continuation-in-part of application No. 11/347,424, filed on Feb. 2, 2006.
(60) Provisional application No. 60/650,364, filed on Feb. 3, 2005.

(51) Int. Cl. G06F 17/00; G06K 7/10

(52) U.S. Cl. 235/375; 235/462.01

(57) ABSTRACT

Systems and methods for product identification using a URL are disclosed here. One embodiment includes generating a plurality of uniform resource locators (URLs), each URL being unique for each item of a set of items, each URL to provide access to the product information associated with each item. Another embodiment includes providing the plurality of URLs to be separately marked on the set of items.

### RELATED APPLICATIONS

This application is a continuation-in-part of U.S. patent application Ser. No. 11/347,424, filed Feb. 2, 2006, which claims priority from Provisional U.S. Patent Application Ser. No. 60/650,364, filed Feb. 3, 2005. The disclosures of the above-referenced prior applications are incorporated herein by reference.

### TECHNICAL FIELD

The present disclosure relates generally to a method and system for product identification using a URL.

### BACKGROUND

To ensure effective product regulation and consumer safety, measures that improve accessibility of product information and authenticity to relevant personnel should be implemented. In one example, bar codes (e.g., QR codes) are used to encode URLs for capture and efficient decoding by a camera phone (e.g., an off the shelf camera phone) having the relevant software for QR code reading. The decoded URL can then be accessed by the camera phone through a network. Since use of camera phones has become widespread, information encoded with QR codes can be conveniently read by anyone carrying a cellular phone with a camera. This method is typically used to provide a link to a web page containing more information about an advertisement of a product or service in a magazine, newspaper, or other printed publication.

Product quality and reliability has become increasingly crucial in the era of global proliferation of goods exchanges and sales. With increased globalization, products are distributed worldwide, and manufacturing may also be carried out globally due to resource variety and/or budgetary considerations. As such, management and supervision of product development and quality control has become a progressively difficult task.

For example, defective products may be manufactured due to operator negligence, and/or equipment malfunctions, etc. Depending on the nature of the product, the defect may cause malfunction (e.g., performance issues of electronics devices, scratched CDs, etc), or have more serious implications that endanger lives in cases such as a malfunctioning pacemaker, incorporation of toxic elements during food processing. In these situations, it may be important to identify the source of the problem in a timely fashion to prevent further distribution and manufacture of defected products. However, due to a diverse supply chain, and global manufacturing plants, identifying the problem source is frequently a time consuming and labor intensive task.

Additionally, advent of technology has encouraged and facilitated product counterfeiting. Product counterfeiting may encompass marketing impure jewelry products, brand-naming generic drugs/non-approved drugs, counterfeiting medicine, and/or brand-naming generic soda. Certain situations result in monetary loss whereas in some situations, lives may be at stake, such as a non-approved drug of unknown origin causing unexpected reactions.

Furthermore, different countries also have different export and import control regulations. Imports of certain products may be regulated and/or prohibited. To circumvent import/export controls and/or taxation issues, products may be disguised and packaged as an alternate product with more lenient regulations and/or lower taxes before shipment across foreign borders. This may significantly impact government tax revenues. The ability to track and monitor distribution of sensitive items (e.g., weapons, drugs, alcohol, medication, etc.) may also be inhibited.

### SUMMARY OF THE DESCRIPTION

Methods and systems for product identification using a URL for product tracking purposes are described here. Some embodiments of the present invention are summarized in this section.

One embodiment includes generating a plurality of uniform resource locators (URLs), each URL being unique for each item of a set of items, each URL to provide access to the product information associated with each item. Another embodiment includes providing the plurality of URLs to be separately marked on the set of items.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### BRIEF DESCRIPTION OF THE DRAWINGS

The disclosure is illustrated by way of example and not limitation in the figures of the accompanying drawings in which like references indicate similar elements.

FIG. 1 illustrates an example of a consumer device and/or a client communicating with a server module to access product identification services using a URL, according to one embodiment.

FIG. 2A is a flow chart describing an overview of an example process of product code request, according to one embodiment.

FIG. 2B is a flow chart describing an overview of an example process of product code authentication request, according to one embodiment.

FIG. 3A is a flow chart describing an overview of an example process of requesting a plurality of unique URLs, each URL being unique for an item or package, according to one embodiment.

FIG. 3B is a flow chart describing an overview of an example process of product information request with an associated URL, according to one embodiment.

FIG. 3C is a flow chart describing an overview of an example process of providing product information in response to receiving a request for product information with a URL, according to one embodiment.

FIG. 4 is a flow chart describing an overview of an example process of a product code/URL authentication request to detect product diversion, according to one embodiment.

FIG. 5 is a flow chart describing an overview of an example process of a product code authentication/URL request to detect product code duplication, according to one embodiment.

FIG. 6A illustrates an example of an alphanumeric representation of an encrypted product code, according to one embodiment.

FIG. 6B illustrates an example of an alphanumeric representation of an encrypted product code encoded as a graphic symbol, according to one embodiment.

FIG. 7A is an exploded view of a server module, according to one embodiment.

FIG. 7B illustrates a block diagram having sources for a set of instructions, according to one embodiment.

FIG. 8 illustrates a screen shot showing one embodiment of a web interface for entering data identifying a batch of product codes.

FIG. 9 illustrates a screen shot showing one embodiment of a web interface for generating a set of product codes based on the batch information that was entered in the screenshot of FIG. 8.

FIG. 10 illustrates a screen shot showing one embodiment of a web interface to verify authenticity of a product code.

FIG. 11 illustrates a screen shot showing one embodiment of a web interface having the results from verifying authenticity of the product code entered in the code field of FIG. 10.

FIG. 12 is a block diagram of a product code during a process of product code generation and encryption, according to one embodiment.

FIG. 13 is a block diagram of a product code during a process of product code decryption and authentication, according to one embodiment.

FIG. 14 is an example conversion table for mapping between encrypted product codes and a corresponding alphanumeric representation, according to one embodiment.

### DETAILED DESCRIPTION

At least some embodiments of the disclosure relate to a method and system of product identification using a URL.

The following description and drawings are illustrative and are not to be construed as limiting. Numerous specific details are described to provide a thorough understanding of the disclosure. However, in certain instances, well known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. Embodiments of the present disclosure include methods and systems for product identification using a URL.

Providing Product Information Using A URL

Bar codes known as QR codes are used to encode URLs in a machine-readable printed format. The barcodes can be read with off-the-shelf camera phones. For example, if the bar code contains a URL, the camera phone can automatically retrieve the associated webpage from a network.

In particular, unit-level unique URLs can be generated and marked on products or packages to track products and/or to authenticate products. These URLs will provide information regarding individual items. When the URLs are encoded as bar codes, an off-the shelf camera phone can be used to retrieve the information in addition to providing authentication of the product.

Providing Product Information with Authentication

The system can be configured to return product information about the product that is being authenticated. In one embodiment, when a request for the plurality of product codes is received, product information associated with the plurality of product codes of a plurality of items is recorded and maintained. The product information can be provided when the request is sent, prior to sending the request, or after the request has been sent.

For example, product information can be supplied when the client engages in the services of the code providing entity. Additional information may be supplied at the time services are rendered (e.g., when a batch of product codes is requested). For clients with a diverse product line, product information may be supplied at the time of the request for the plurality of product codes. Furthermore, additional product information may be supplemented after product codes for the items have been generated. For example, product defects detected after manufacturing and packaging can be supplied to the code providing entity. Upon authentication, defect information can be provided to an end user.

In one embodiment, product information is maintained and organized upon receipt for the plurality of items and the product information is also associated with the plurality of product codes generated for the plurality of items. As such, the product information associated with the product code of the item can be identified in response to receiving a request to authenticate the product code. During authentication, it is determined whether the product code is one of the generated product codes.

The plurality of product codes may be generated by the code service provider or by the client at a client site, according to one embodiment. The plurality of product codes generated at the site of the code service provider can be sent to the client site over a secure network. In addition, the product codes can be generated at the client site where key information (e.g., encryption key) used to generate product codes is provided over a secure network to the client by the code service provider.

Security Information

In one embodiment, the product information includes one or more of details of security features of the item, where the security features are covert or overt, a time attribute, a location attribute, a work order, a lot number, a manufacturing information, a use-by date, an operator name, a manufacturing plant, a universal product code (UPC), a product description, a package size, a package quantity, a packaging image of the item, or a pre-identified destination of the item. The security features can include holograms, color-shifting ink, taggants, micro-texts, magnetic ink, up-shifting phosphors, etc.

A common issue with security features of a product is that customs or law enforcement officials do not have enough information about the security features. For example, officials may not know that they exist, or how to identify them, or how to interpret them. By providing clear instructions on what to identify and how to interpret the features that are identified with product information associated with a product code, the value of the security features can be enhanced.

Marking Product Codes and URLs

In one embodiment, the plurality of product codes are marked onto product labels upon receipt where each unit item has a different product code. The product codes can be marked onto the products at the site of the coding service provider, or the product codes can be marked onto the products at the client site.

In one embodiment, the product codes are marked with any type of printing system suitable for printing product codes on products, labels and/or product packaging. For example, the printing device used may be a high-speed industrial inkjet printer (with visible or invisible ink), a thermal transfer printer, and/or a laser marker, etc. In some embodiments, special invisible inks may be utilized to covertly mark products with invisible codes. The product code may uniquely identify a product or a class of product. In one embodiment, the product code is marked as a bar code and the information is retrieved from the computer system by reading the bar code with a camera phone.

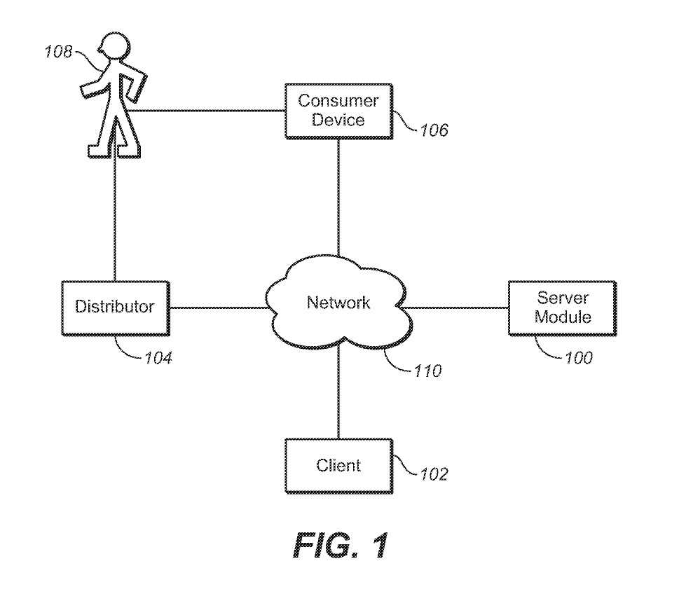

FIG. 1 illustrates an example of a consumer device 106 and/or a client 102 communicating with a server module 100 to access product information coding and authentication services through a network 110, according to one embodiment.

The server module 100 may be operated by an entity that offers services related to product identification using a URL to one or more clients 102. For example, the client 102 having multiple manufacturing and/or packaging sites may be serviced by a server module 100 at each site, as needed. Alternatively, the server module 100 may service a variety of clients 102 associated with different companies having similar or different products. The server module 100 may also service various sites of the same company.

In one embodiment, the server module 100 may maintain client information such as product lines, manufacturing sites, and/or dates of production associated with a particular batch request to be associated with management of client specific encryption/decryption keys. In one embodiment, each client 102 has a unique key. In alternate embodiments, unique keys may be assigned to each product line for the client 102, a new key can be generated periodically for each client 102, or a new key is generated based on frequency of usage by the client 102. In addition, a different key may also be associated with products manufactured from a different manufacturing site of the client 102. In an alternate embodiment, each client uses the same encryption/decryption key.

In one embodiment, a set of unique product codes having a common check value as a section of the product code is generated and the set of unique product codes can be authenticated by comparing the check value section of the product code to the check value which is a constant value for the product codes for a batch.

The network 110, over which the client 102, the consumer device 106 and the server module 100 communicate, may be an open network, such as the internet, or a private network, such as an intranet. In one embodiment, communications to and from the server module achieved by a means of secure communications protocol, such as secure sockets layer (SSL), or transport layer security (TLS).

The client 102 may be any of the various facilities of an organization involved in the process of delivering a product to the marketplace. Based on specific business processes and product delivery procedures of the particular organization, the client 102 may be integrated where suitable in the production line.

For example, the client 102 may be employed during manufacturing, prototyping, packaging, and/or distribution. The client 102 may also be employed at a combination of facilities as necessary and communicating a request to the server module 100 for a set of product codes or URLs to be placed on the product. In one embodiment, information regarding the product and/or the company itself may be sent to the server module 100 along with the request for product codes/URLs to be encoded in the product code such that information about the product can be revealed to a relevant party (e.g., a consumer or a distribution center, a customs officer, etc.) when the product code is decoded to be authenticated. In an alternate embodiment, product information may be associated with the generated product codes/URLs and provided to the code authentication requestor. The product information provided to the code authentication requester may be dependent on the identity of the code authentication requestor.

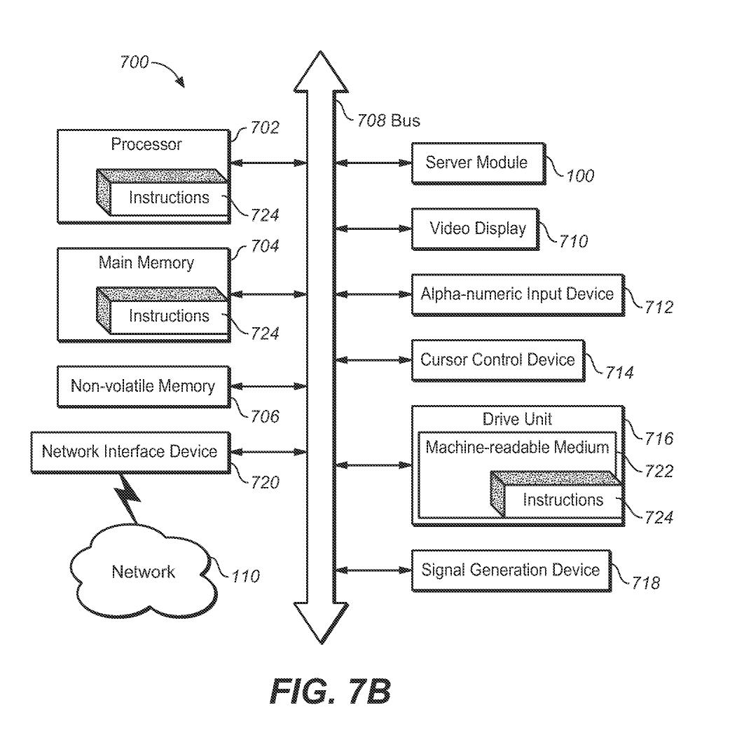

For example, the screen shot 800 of FIG. 8 illustrates a screen shot showing one embodiment of how the client 102 can enter data identifying a batch of product codes and/or URLs. The data entered can be associated with the generated product codes/URLs and can be provided to a product code authentication requester. In one embodiment, the data entry fields include a manufacturing site drop down box 802, a production line drop down box 804, a product selection drop down field 806, a order number field 810, a lot number field 812, a destination field 814, an expiry date field 816, a country of origin field 818, and a field indicating planned quantity 820 of product codes/URLs to be generated. The batch information can then be submitted to the server module 100 when the ‘start batch’ button 822 is activated for product code generation by the server module 100. Less than all of these features could be included, or alternative features could be included.

Batch information can be submitted through a web interface 800 to the server module 100 which generates a set of product codes based on the batch information and returns the set of product codes to the client 102. The set of product codes can also be marked directly on products. In one embodiment, product code generation capabilities reside on the client 102 and the web interface 800 is utilized to generate a batch of product codes at the client 102 site with an encryption key received from the server module 100 and stored at the client 102 site.

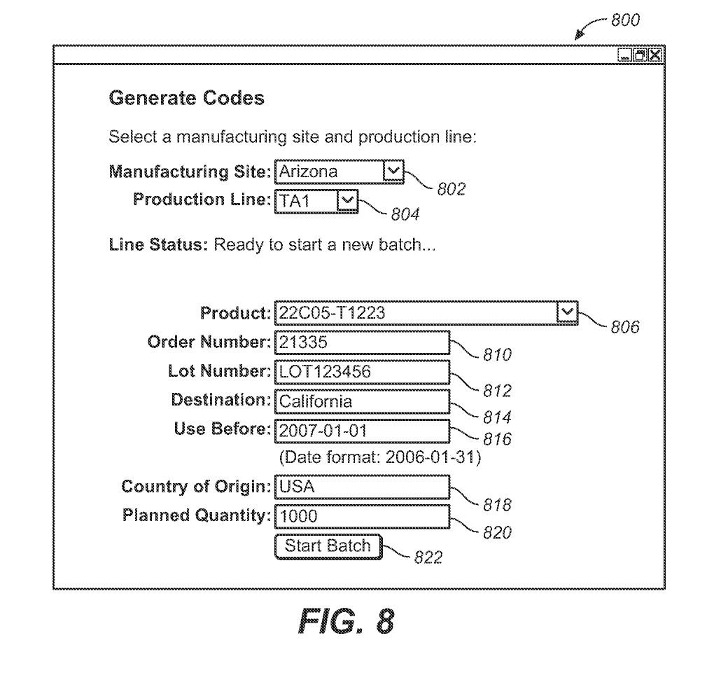

Furthermore, the screenshot 900 of FIG. 9 illustrates a screen shot showing one embodiment of how the client 102 can request generation of the set of product codes/URLs based on the batch information that was entered in the screenshot 800 of FIG. 8. For example, the number of product codes/URLs to be generated can be entered in the count field 902, and a printer can be selected in the printer field 904 to be used to print the set of product codes on products. In one embodiment, when the generate product codes button 906 is selected, a set of product codes/URLs for the respective batch is generated by the server module 100 and displayed in the display box 908. The client 102 can receive the generated product codes on the screen as shown. In one embodiment, the product codes/URLs can be directly sent to a marking system to be placed and applied to products. In one embodiment, the product codes/URLs are generated at the client 102 site with an encryption key assigned by the server module 100.

The consumer device 106 may be any device having networking capabilities (e.g., mobile phone, PDA, notebook, desktop computer, etc.) able to send a product code/URL that is to be authenticated through the network 110 to the server module 100. For example, the consumer device 106 may be operated by a store manager, a supply manager of a medical clinic, a consumer at a shop, a user of a product to determine authenticity of the product code/URL corresponding to a particular product to verify the product origin and to detect counterfeits.

The product code/URL may be captured by the consumer device 106 in various methods including keyed entry from a keyboard, a telephone keypad, a camera, and/or a bar code reader and sent to the server module 100 for validation. In one embodiment, the product code may be sent via email, text messaging, and telephonic capabilities of the consumer device 106 to the server module 100 for authentication. In another embodiment, the product code may be authenticated via a webpage access of data maintained by the server module 100 to locate information associated with the product having the particular product code. Furthermore, the product code can be represented by a bar code that is scannable by an image capturing device. The scanned image can then be sent over the network to the server module 100 for authentication. In one embodiment, the bar code is a 2D bar code in a QR format that is able to be read by camera phones with QR reading capabilities. The URL associated with the QR code can then be decoded and the web page can be accessed.

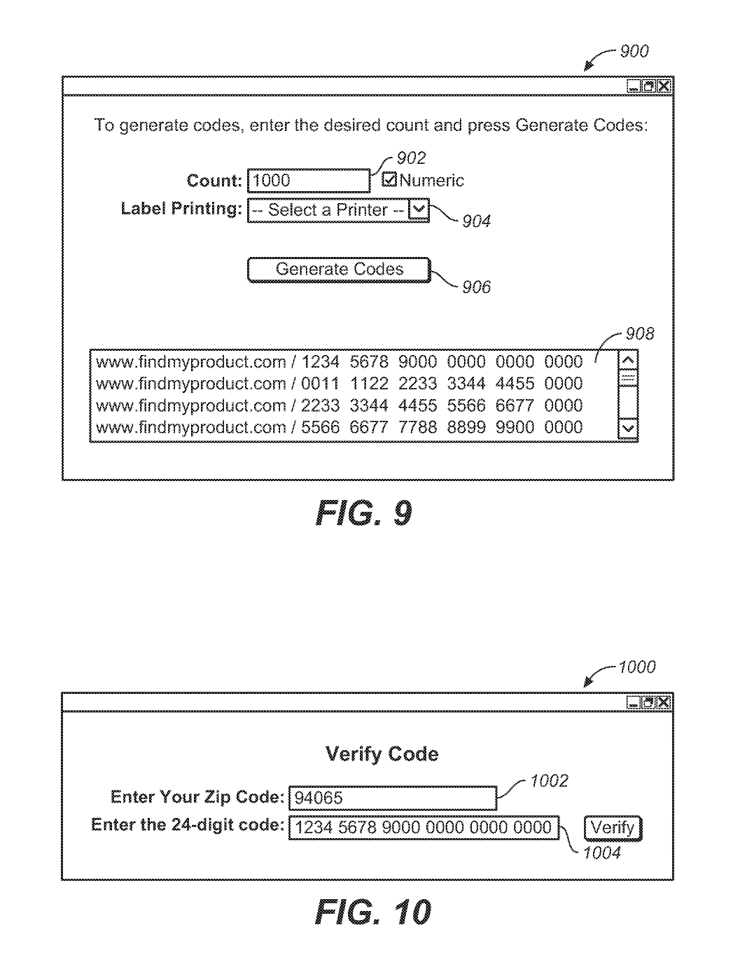

For example, the screenshot 1000 of FIG. 10 illustrates a screen shot showing one embodiment of a web interface to verify authenticity of a product code/URL. In one embodiment, the zip product code of a location of authentication can be entered in the zip code field 1002 and the product code can be entered in the code field 1004. Once the verify button is activated, the information entered can be used to locate information associated with the product code/URL entered in the code field 1004 and authenticity of the product code/URL is determined by the server module 100. In one embodiment, the zip code of location of authentication is used by the server module 100 to track usage of generated product codes for duplication detection and to track destination of products. In addition to communicating authentication results to the consumer device 106, alternate information revealed during the decryption process, such as product information, expiration date, manufacturing location, may also be communicated to the consumer device 106 and displayed accordingly.

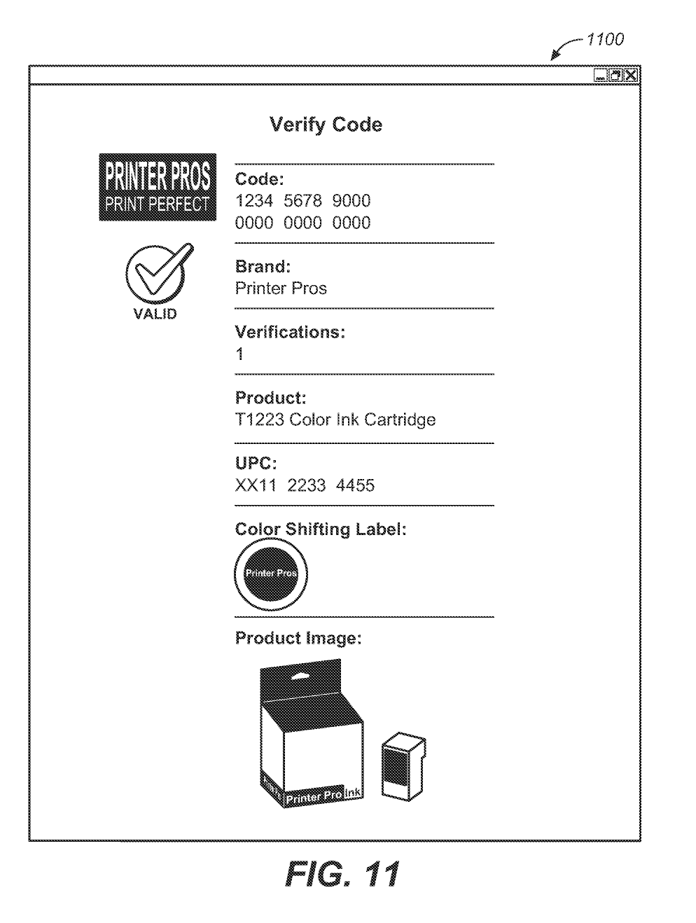

For example, the screenshot 1100 of FIGURE 11 illustrates a screen shot showing one embodiment of a web interface having the results from verifying authenticity of the product code/URL entered in the code field 1004 of FIGURE 10. In this example, the product code/URL was determined to be valid as indicated by a check mark icon labeled ‘valid’. Furthermore, product information including the brand, type of product, UPC code is also determined and displayed on the verification screen. In one embodiment, a product image is also displayed. In another embodiment, the number of times this product code has been verified is also reported to detect potential duplicate product codes. Also included is the image of the color shifting label, which is a secondary security feature of the product.

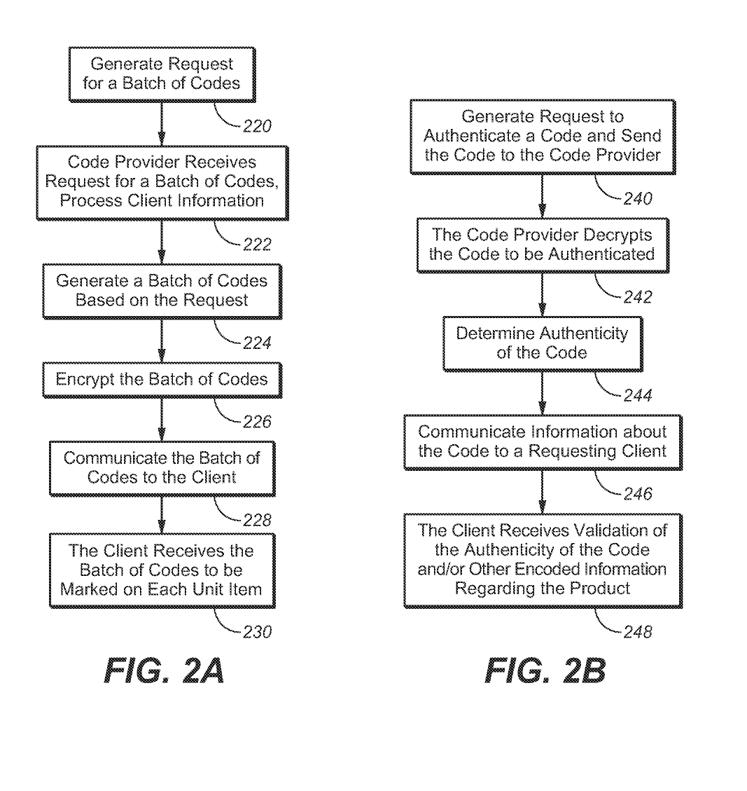

FIG. 2A is a flow chart describing an overview of an example process of product code request, according to one embodiment.

In operation 220, a request for a batch of product codes is generated. In one embodiment, the request may also include relevant product information and/or client information. In operation 222, the code provider receives the request for a batch of product codes and processes the client information, in one embodiment. In operation 224, the batch of product codes is generated based on the request including client information and/or relevant product information. The batch of product codes may be generated at the client site or at the code provider site. In operation 226, the batch of product codes is encrypted. In operation 228, the batch of product codes is communicated over a secure network to the requesting client if the product codes are generated at the code provider site. Alternatively, the requesting client may instead receive key information from the code provider to generate product codes on site. In operation 230, the client receives the batch of product codes to be marked on each unit item, if the code provider generated the product codes.

FIG. 2B is a flow chart describing an overview of an example process of product code authentication request, according to one embodiment.

In operation 240, a request to authenticate a product code is generated. In one embodiment, the product code is sent to the code provider. In operation 242, the product code to be authenticated is decrypted (by the product code provider). In one embodiment, the code authentication is performed by the code provider. In alternate embodiments, the code authentication can be provided by an organization authorized by the code provider. In operation 244, authenticity of the product code is determined. In operation 246, the information about the product code is communicated to the requesting client. In operation 248, the client receives validation of the authenticity of the product code and/or any other encoded information regarding the item.

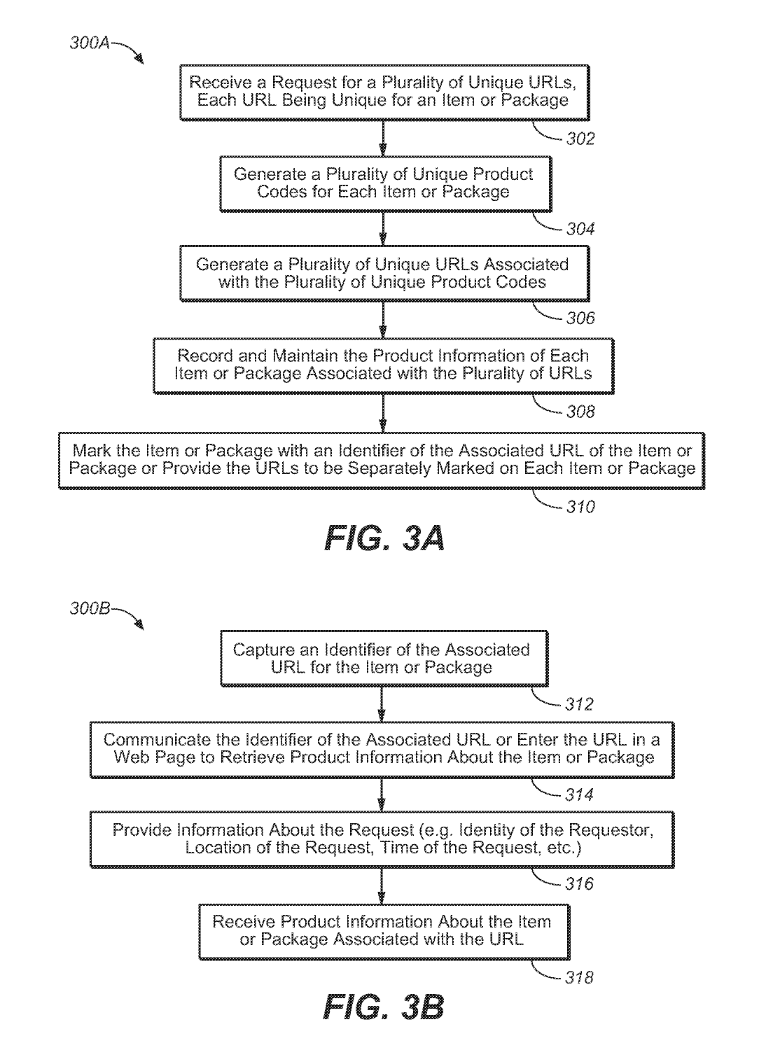

FIG. 3A is a flow chart 300A describing an overview of an example process of requesting a plurality of unique URLs, each URL being unique for an item or package, according to one embodiment.

In process 302, a coding service provider receives a request to generate a plurality of unique URLs, where each URL is unique for an item or package. In operation 304, a plurality of unique product codes is generated for each item or package. In one embodiment, the plurality of unique product codes are generated with any suitable encryption algorithm. In a current embodiment, the plurality of unique product codes are encrypted (and decrypted) with a triple DES encryption algorithm.

In process 306, the plurality of unique URLs are generated through association with the plurality of product codes. In one embodiment, the product code is appended to a generic URL. The generic URL may be associated with the coding service provider. Alternatively, the generic URL may also be associated with the client, a brand, and/or a particular product. As such, at least a portion of the URL (e.g., the appended unique product code) is unique for each item or package.

In another embodiment, the plurality of unique URLs does not include a generic portion. A substantial portion of the plurality of unique URLs may be a unique identifier based on the associated product code of the item or package.

In process 308, the product information of each item or package associated with the plurality of URLs is recorded and maintained, for future access. The marking of the identifier of the URL can be covert or overt. In one embodiment, the identifier is marked as a bar code that is scannable by image capturing devices. Additionally, the identifier may be a 2D bar code. In process 310, the item or package is marked with an identifier of the associated URL of the item or package. In another embodiment, the URLs are provided to be separately marked on each item or package.

FIG. 3B is a flow chart 300B describing an overview of an example process of product information request with an associated URL, according to one embodiment.

In operation 312, an identifier of the associated URL of the item or package is captured. For example, the identifier can be captured by a shopper, an end user, a distributor, or a shipment carrier. In one embodiment, the identifier is captured manually. For example, the identifier may be manually typed into the URL field of a web browser. The identifier may also be entered with a keyboard of a portable device. The identifier can be manually saved for future use. In an alternate embodiment, the identifier is automatically captured with an image capturing device such as a digital camera, a camera, digital cameras built into portable devices (e.g., cell phones, PDAs, laptop computers etc), or a scanner.

In operation 316, the identifier of the associated URL is communicated to the coding service provider. For example, the captured image of the identifier is automatically sent through a network to the coding service provider. The identifier can be sent via email, SMS, and/or any secured protocol. In an alternate embodiment, the identifier can also be communicated via voice over a telephonic network (e.g., wireless, landline) to retrieve product information through an automated interface or from a service agent. In an alternate embodiment, the URL is entered in a web page to retrieve product information about the associated item or package.

In operation 314, information about the request is provided to the coding service provider. In one embodiment, information such as the identity of the requester, location of the request, or time of the request can be supplied by the requestor. In another embodiment, the information above is automatically supplied to the code service provider with the request. For example, for a request generated through telephonic means, the originating phone number can be used to identify the requestor. Similarly, an IP address can be used to locate origination of the request and in some instances, the identity of the requester. Similarly, a zip code supplied with the request can be used to locate the request. For example, a portable device with GPS capabilities may automatically include location information as indicated by zip codes with requests.

In operation 318, the product information about the item or package associated with the URL is received by the requester. Similarly, the product information can be received via any electronic means such as on a portable device via email, SMS, or voice mail. The product information can also be provided through a web page. Alternatively, product information can be communicated via a telephonic service where information is delivered with automated voice system or a live service agent. In one embodiment, the providing at least part of the previously received product data, is dependent on an identity of a requester. For example, the requester can be one or more of customs officials, law enforcement officials, supply chain personnel, end consumers, distributors, and/or retailers.

FIG. 3C is a flow chart 300C describing an overview of an example process of providing product information in response to receiving a request for product information with a URL, according to one embodiment.

In process 322, the coding service provider receives a request for product information associated with a URL. In operation 324, the received URL is associated with the product information of the item or package. In operation 326, authenticity of the URL is verified. Authenticity can be verified with any suitable decryption algorithm in accordance with the encryption algorithm used to generate at least part of the URL. In operation 328, results of authenticating the URL is provided to the requester. In operation 330, information such as requester identity, location of request, and time of request, associated with the request is processed.

In operation 332, at least a portion of the product information associated with at least a portion of the URL is provided based on the information associated with the request. For example, different information is provided to an end user versus a customs official. Taxation information and country of origin of the product may be provided to the customs official whereas an expiry date of the product may be provided to the end user.

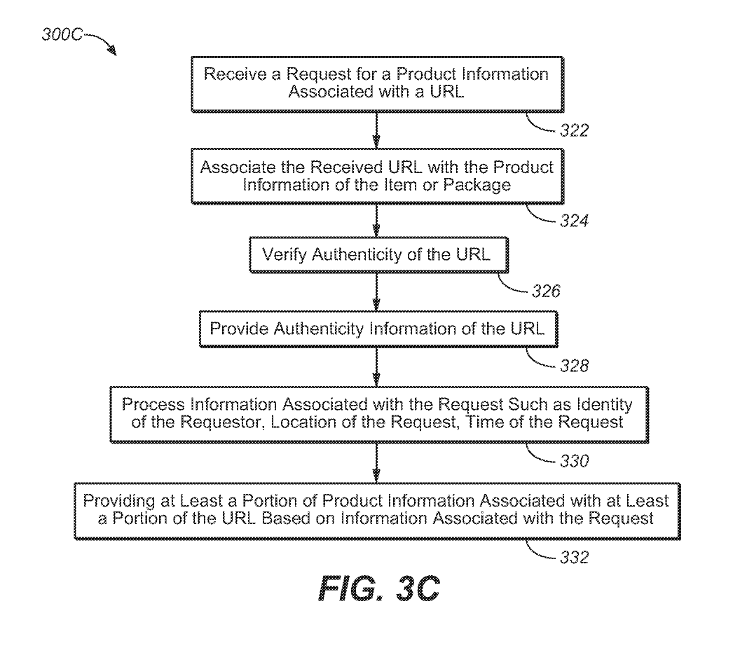

FIG. 4 is a flow chart 400 describing an overview of an example process of a product code authentication request to detect product diversion, according to one embodiment.

After a product code has been authenticated, the product code is associated with the pre-identified destination of the item or package in process 402. In one embodiment, the destination is one or more of a continent, a country, a state, a city, a province, country, a street, a home address, and/or a business address.

In process 404, the recorded location of the item is compared with a pre-identified destination of the item for which the product code is being authenticated and a result of the comparison is recorded. The recorded result can indicate whether the recorded location matches the intended location. In addition, the distance between the pre-identified destination and the recorded location of the item can be determined. Authentications that may occur while the item is en route to its destination is also taken into account by associating the route to destination with the product information.

In process 406, a number of times the location of the item is different from the pre-identified destination of the item is determined. For example, recorded locations of authentication that are en route to the destination will not be counted against a predetermined threshold beyond which diversion is suspected. In addition, resales (e.g., yard sale, ebay, Amazon sales) by the original owner may also result in authentication location different from the intended location.

In one embodiment, the location records are also analyzed based on other criterion that would deem a shipment illegally diverted. For example, individual items may be resold to other locations and should not be considered product diversion. However, a large number of items authenticated in an unanticipated location may indicate that the associated products have been diverted in the supply chain.

In process 408, the item for which the number of times equals or exceeds a predetermined threshold is reported. In an alternate embodiment, if the analysis of shipment records imply suspected diversion activity based on criterion other than the number of times of unexpected item location, a report is also generated.

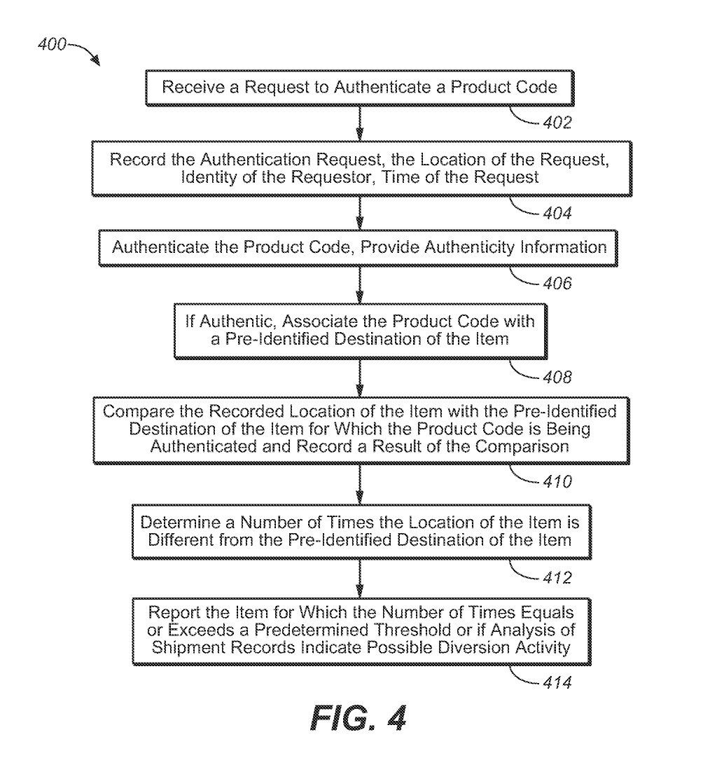

FIG. 5 is a flow chart 500 describing an overview of an example process of a product code authentication request to detect product code duplication, according to one embodiment.

After a product code has been authenticated, the number of instances the product code has been authenticated is determined in process 508. Since unique product codes are generated for each item or package, a counterfeiter cannot generate authentic codes that will be authenticated due to the encryption algorithm used for code generation. As such, counterfeiters may copy valid codes from authentic products/packages and replicate onto counterfeit products. Therefore, duplicate authentication requests of a product code is monitored according to one embodiment. During authentication of the product code, an identity of an authentication requester and time of authentication may be recorded. In addition, the location of the item can be recorded based on geographical data of the authentication of the product code of the item.

In process 510, the number of instances the product code has been authenticated is compared to a predetermined threshold indicating unauthorized duplication. In one embodiment, the predetermined threshold is based on at least one of a type of product being authenticated, and a location of product distribution and authentication. The number of instances the product code has been authenticated is tracked and recorded. The authentication record can be inspected and analyzed along with timing data of authentication to determine whether the product code has been duplicated. In one embodiment, multiple authentications of the product code is considered as one instance when each authentication is performed under predetermined circumstances based on at least one of the identity of the authentication requestor, the location of the item, and the time of authentication.

For example, the multiple authentications of the product code can be considered as one instance when authenticated by the authentication requester having a same identity. The multiple authentications of the product code is considered as one instance when each authentication of the multiple authentications is performed within a predetermined amount of time, or when each authentication of the multiple authentications is performed within a predetermined geographic distance of one another.

In another embodiment, the identities of the authentication requestors are classified into two or more groups where the groups include at least one of a customs official, law enforcement official, supply chain personnel, distributors, retailers, and end consumers. The counting of the number of instances the product code has been authenticated for each of the two or more groups may occur separately and count against different thresholds. In one embodiment, a different threshold is determined for each group.

In process 512, the item for which the number of instances the product code has been authenticated equals or exceeds the predetermined threshold is reported. In one embodiment, the item for which the number of instances the associated product code has been authenticated equals or exceeds at least one of the thresholds for each of the two or more groups is reported.

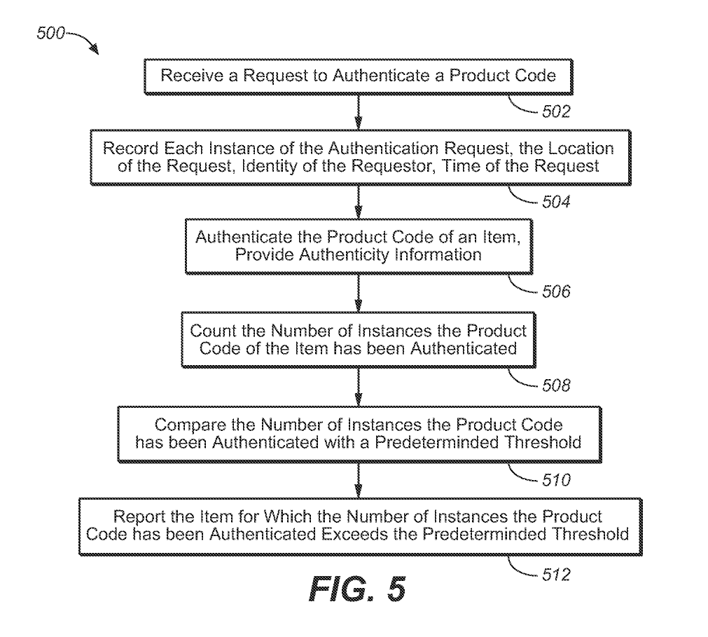

FIG. 6A illustrates an example of an alphanumeric representation of a product code, according to one embodiment. In one embodiment, the product code may be a string of sixteen alphanumeric characters consisting of numbers and letters, such as the product code 602. By utilizing different combinations of sixteen alphanumeric characters, more than a million, billion, billion (10²⁴) unique product codes may be generated. However, it will be appreciated by one skilled in the art that alternative embodiments of the invention may use a product code that is more or less than sixteen characters in length, and may use a product codes that makes use of the entire set of ASCII characters.

FIG. 6B illustrates an example of an alphanumeric representation of a product code/URL 604 encoded as a graphic symbol, according to one embodiment. In particular, the product code/URL 604 is a special machine readable graphic symbol known as a datamatrix. A datamatrix is a two-dimensional matrix barcode consisting of black and white square modules arranged in either a square or rectangular pattern. Similar to a traditional barcode, a datamatrix can be read by a machine, such as a matrix barcode reader. Encoding an alphanumeric representation of the product code in a graphic symbol, such as the datamatrix 604, provides several advantages. First, error correction and redundancy are built-in to the datamatrix 604. Consequently, a product code represented as a datamatrix can still be read if it becomes partially damaged. Another advantage is the small footprint, or size, of the datamatrix. A datamatrix can encode as many as 50 characters in a three by three millimeter square, which can be discretely positioned on a product, a label, or product packaging. Finally, the datamatrix can be quickly and easily read by a machine.

Of course, it will be appreciated by those skilled in the art that in various alternative embodiments, product codes may be encoded with other graphic symbologies, for example, such as barcode fonts consistent with the PDF417 or QR Product code standards. In one embodiment, both versions of the product code 602 and 604 may be included on the product, label, or product packaging. For example, the alphanumeric representation of the product code 602 and the graphic symbol representation 604 may appear together on the product, label or product packaging. This provides a wide range of possible methods and mechanisms for reading and communicating the product code for authentication. In one embodiment, when extra security is required, the product codes may be applied or marked on the product, label, or product packaging in a covert manner, such that a consumer is not aware of the existence of the product code.

For example, the product codes may be applied to the products, labels or product packaging with a special invisible ink or other chemical-based application making the product code invisible to a consumer. According to the type of invisible ink or chemical used to apply the product code, reading the product code may require the application of heat, ultraviolet light, or a chemical. This approach may be utilized when someone in the supply or distribution chain other than the consumer is likely to be authenticating the product. For example, a covert product code may be provided for the purpose of authenticating products by customs officials.

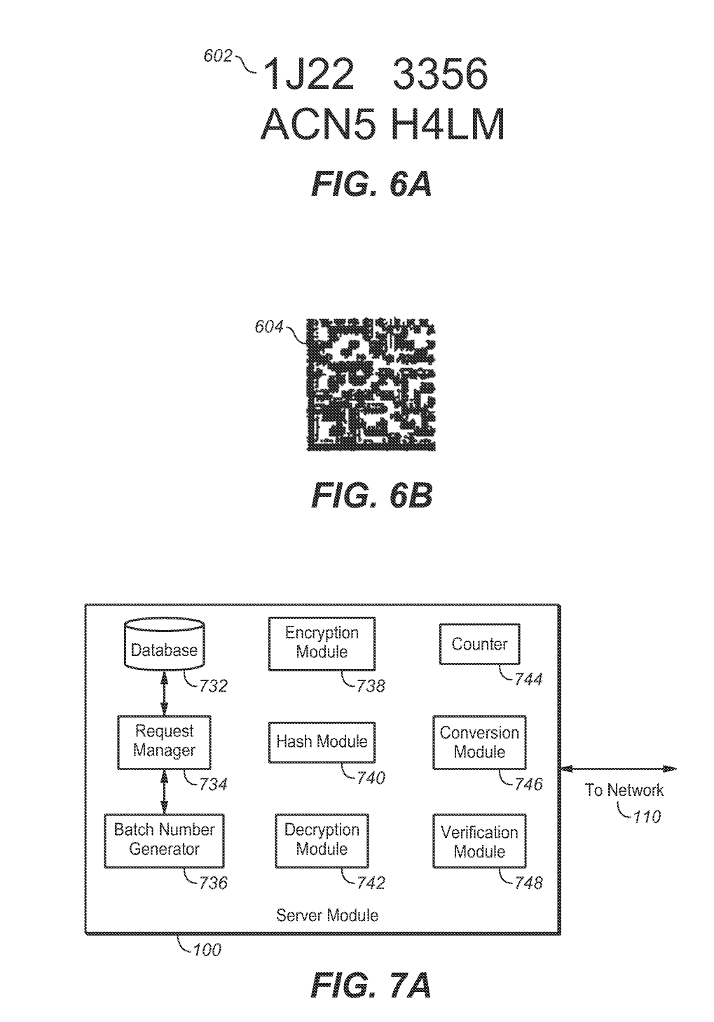

FIG. 7A is an exploded view of a server module 100, according to one embodiment. The server module may include a database 732, a request manager 734, a batch number generator 736, an encryption module 738, a hash module 740, a decryption module 742, a counter 744, a conversion module 746, and/or a verification module 748. In alternate embodiments, additional modules may be included, or less modules, or some modules on separate systems.

In one embodiment, the server module 100 receives a request for a batch of product codes, with each product code to be unique for a separate unit item. In one embodiment, the request manager 734 may process client requests for product code generation by initially assigning a key-ID for a new client or identifying a key-ID that has been previously assigned to an existing client in the database 732. In one embodiment, the key-ID is an identifier to an encryption key (e.g., a triple DES encryption key) that is used to encrypt the batch of product codes. The key-ID may be unique for a particular client, a specific customer, a manufacturing plant, and/or a production line. The key-ID may also be updated periodically, or after a predetermined number of usages.

In one embodiment, the database 732 maintains information about each key-ID of the client (customer) along with its associated encryption key. In alternate embodiments, the key-ID is associated with each product of a client. The update frequency of the key-ID can also be maintained in the database 732. It can also be envisioned that in some embodiments, a key-ID is not used to identify the encryption key for a particular client. The same encryption key may be used for each client.

In one embodiment, the database 732 also retains the product information associated with the plurality of product codes/URLs of the plurality of items. The product information includes one or more of details of security features of the item, the security features are covert or overt, a time attribute, a location attribute, a work order, a lot number, a manufacturing information, a use-by date, an operator name, a manufacturing plant, a universal product code (UPC), a product description, a package size, a quantity, a packaging image of the item, or a pre-identified destination of the item. According to one embodiment, the pre-identified destination of the item is identified by a country, city, state, province, zip code, street address, a home address, and/or a business address.

In one embodiment, information related to authentication of the plurality of product codes/URLs is also stored in the database 732. For example, the location of the item being authenticated may be recorded to determine if the location of the item being authenticated is consistent with the expected destination of the item to detect product diversion. The item for which the number of inconsistent authentications (authentications where the location is different from the intended location) equals or exceeds a predetermined threshold can be reported.

In one embodiment, the predetermined threshold can be different for each client, product, and/or breadth of product distribution. For example, distribution of pharmaceuticals may be significantly more geographically confined than a household supply such as toothpaste due to different regulations in different parts of the world. Distribution of certain products may be illegal in some countries while legal in others. The above attributes contribute to at least partially determining the predetermined threshold of inconsistent authentications that constitutes suspected diversion activity. In one embodiment, identified locations of product code/URL authentication located within a particular distance of the pre-identified destination of the product are considered to be consistent authentications and a product diversion alert is not triggered.

Furthermore, resale of products (e.g., a yard sale, an (online) auction, an online resale, etc.) may also result in product delivery to locations different from the original pre-identified destination of the product. Instances of product resale may be estimated and taken into account into determination of the predetermined threshold. In alternate embodiments, the product code/URL is used to track delivery of a product. If the product is lost during shipping (e.g., delivered to the wrong address), the product can be located by the shipper and/or the intended recipient. Additionally, product code/URL authentication during shipment of a product can be taken into account. According to one embodiment, the transit route of the product is maintained in the database 732 and authentication during transit before arrival at the destination is not considered an inconsistent authentication.

Since valid product codes cannot be counterfeited without knowledge of the encryption key, counterfeiters may replicate valid codes and mark them on alternate products or packages. Therefore, each instance of authentication of a product code is recorded and stored in the database 732. The number of instances the product code has been authenticated is counted to track replication of valid product codes on to more than one item. The number of instances the product code has been authenticated is compared to a predetermined threshold to determine counterfeiting activity due to product code duplication.

In one embodiment, an identity of the code authentication requestor, the location of authentication, and the time of authentication is recorded and stored in the database 732. Additionally, the time interval between authentications of the same product codes may also be recorded. An algorithm determining the predetermined threshold takes into account at least some of the above stated factors. In one embodiment, multiple authentications of the same product code is monitored and analyzed based on the above indicated attributes of the authentications. For example, the same item may be authenticated twice when a distributor receives a product and when a consumer decides to purchase a product. Another instance of authentication may also occur when the consumer is to use the product.

As such, authentications of the same product code/URL performed under a particular set of circumstances may be considered as one instance based on one or more of identity of authentication requester, authentication time, authentication location. For example multiple authentications can be considered as one instance when the multiple authentications are performed by a requester having the same identity, when each authentication is performed within a predetermined amount of time, or when each authentication is performed within a predetermined distance of one another.

In one embodiment, the identity of the code authentication requestor is determined by an IP address, a phone number with an active user account, cookies on a browser, or a user name, etc.

The request manger 734 may communicate client information (e.g., product information including product name, lot number, production date, and/or line operator etc.) to the batch number generator 736. In one embodiment, the batch number corresponds to a batch of products that are produced in a predetermined unit of time, or a predetermined location.

For example, all toothpaste produced by Toothpaste Factory between 8 AM-11 AM may have one batch number and all toothpaste produced by Toothpaste Factory between 11 AM-1 PM may have another batch number. Additionally, toothpaste produced by Toothpaste Factory between 8 AM-11 AM at an alternate manufacturing site may yet have a different batch number. In one embodiment, each key-ID corresponds to a separate set of batch numbers.

For example, all Toothpaste Factory toothpaste may have one key-ID with different batch numbers dependent on time and place of manufacture. Alternatively, all Toothpaste Factory toothpaste manufactured at location A may have one key-ID and have different batch numbers depending on time of manufacture, and all Toothpaste Factory toothpaste manufactured at location B may have different batch number dependent on time of manufacture. In one embodiment, the database 732 retains information about each client and their associated batch number. The criterion used for batch number assignment (e.g., location based, time based, or a combination thereof, etc.) may also be stored in the database 732.

In one embodiment, a different batch number is used for each client if one encryption key is used for every client to avoid duplicate codes being generated.

In one embodiment, an item number is a unique number assigned to each item of a particular batch of items having the same batch number. An item typically corresponds to a single product or a single package. In one embodiment, the item numbers may be sequential having increments of one. In alternate embodiments, the item numbers may be incremented or decremented in other units. In one embodiment, each batch number has a separate set of item numbers. Since information is retained about the batch number assignments in the database, the server module 100 may not retain item numbers, according to one embodiment.

In an alternate embodiment, an additional value (e.g., an alternate value) is used to associate multiple codes with one unit to avoid codes that contain potentially offensive or inappropriate words. In one embodiment, when a code is verified, the alternate value is ignored during the authentication process. In other words, codes having the same key-ID, batch number, and item number identify a same item even though they may have different alternate values.

In one embodiment, the counter 744 generates item numbers for a set of items with a particular batch number. The counter 744 may store the actual number of item numbers generated for the particular batch number and stored in the database as with the batch information.

In one embodiment, an alternate value may also be combined with the series of identifiers before encryption of the code. In a preferred embodiment, a triple-DES encryption algorithm (e.g., having 168 bit key length) is applied by the encryption module 738 to the combination of the series of identifiers. In alternate embodiments, other encryption algorithms may be applied. Since the check value is a predetermined constant value, a check value extracted from the decrypted code is compared to the expected value to determine authenticity of the code during the authentication process. In one embodiment, the check value is chosen to have a combination of zero bits and one bits to increase security of the encryption. Alternative check values may also be used.

In one embodiment, the encryption module 738 uses an encryption key to perform the triple DES encryption and each encryption key can be identified by the key-ID and may be stored in the database 732. In alternate embodiments, code providers at customer sites may also have access to their own encryption key.

In one embodiment, a version indicator can be used to support future versions of the coding algorithm. In the current embodiment, the version indicator having a value of zero is used. The value of one can be reserved for future use with alternate versions of the coding algorithm. In one embodiment, the version indicator and the key-ID can be combined into a word and obscured through computing a Boolean logic or arithmetic function (e.g., exclusive OR, NOR, AND, etc.) of the word and a hash of the encrypted value of the series of identifiers (e.g., a combination of the batch number, item number, and check value). In one embodiment, the hash can be computed by applying the Boolean logic or arithmetic function (e.g., exclusive OR, NOR, AND, etc.) between sub-words of the DES encrypted block by the hash module 740. One purpose of obscuring the key-ID and the version indicator allows codes to appear random.

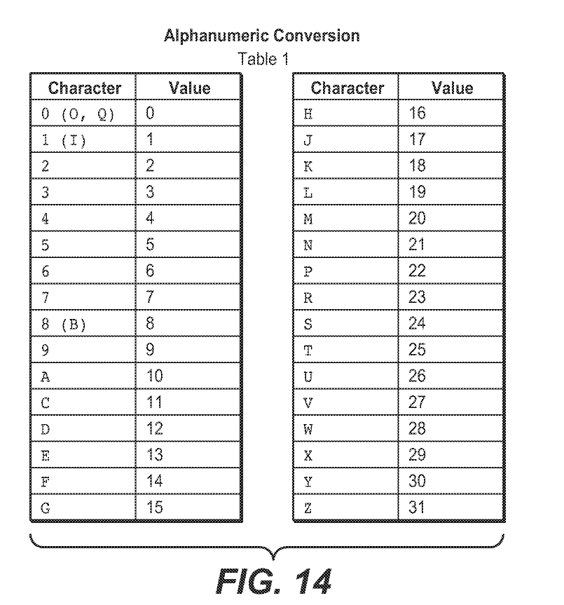

The encrypted code is a combination of the obscured value of the key-ID and version indicator with the encrypted value of the series of identifiers. In one embodiment, the encrypted code can be divided into smaller blocks (e.g., nibbles) and each block can be converted into an alphanumeric character by the conversion module 746. For example, each block may be converted into one of the thirty-two alphanumeric characters based a mapping illustrated in Table 1 of FIG. 14. In the embodiment shown in FIG. 14, the characters include the ten digits and twenty-two of the twenty-six upper case ASCII letters. In this embodiment, the letters O, Q I, and B are omitted to prevent confusion with the number digits 0, 1, and 8.

When a request for code authentication is received from a client, the conversion module 746 may also reference Table 1 to convert the alphanumeric representation to the original binary representation. Furthermore, during the authentication process, the decryption module 742 may use the encryption key identified through the key-ID extracted from the encrypted code to decrypt the encrypted code such that the check value can be extracted and compared to the expected value. In one embodiment, the verification module 748 compares the extracted batch number, and check value to expected values to determine validity of the encrypted code. Additionally, the verification module 748 may also compare the item number with the actual number of codes generated for a particular batch. If the item number equals or exceeds the total number of codes generated, then the code is determined invalid. In alternate embodiments, the check value may be a constant value used for one or more batches of codes.

It will be appreciated by one skilled in the art that the server module 100 illustrated in FIG. 2 has been provided as one example or embodiment of the disclosure, and is not meant to be limiting in nature. The module may include other logic and functional or modular components, the description of which has not been provided to avoid unnecessarily obscuring the invention.

FIG. 7B shows a diagrammatic representation of a machine in the exemplary form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server (e.g., the server module 100) or a client 102 machine in a client-server network environment, or as a peer machine in a peer-to-peer (or distributed) network environment. In one embodiment, the machine communicates with the server module 100 to facilitate operations of the server module and/or to access the operations of the server module.

The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Furthermore, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor 702 (e.g., a central processing unit (CPU) a graphics processing unit (GPU) or both), a main memory 704 and a nonvolatile memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720. The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media. The software 724 may further be transmitted or received over a network 726 via the network interface device 720. While the machine-readable medium 722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

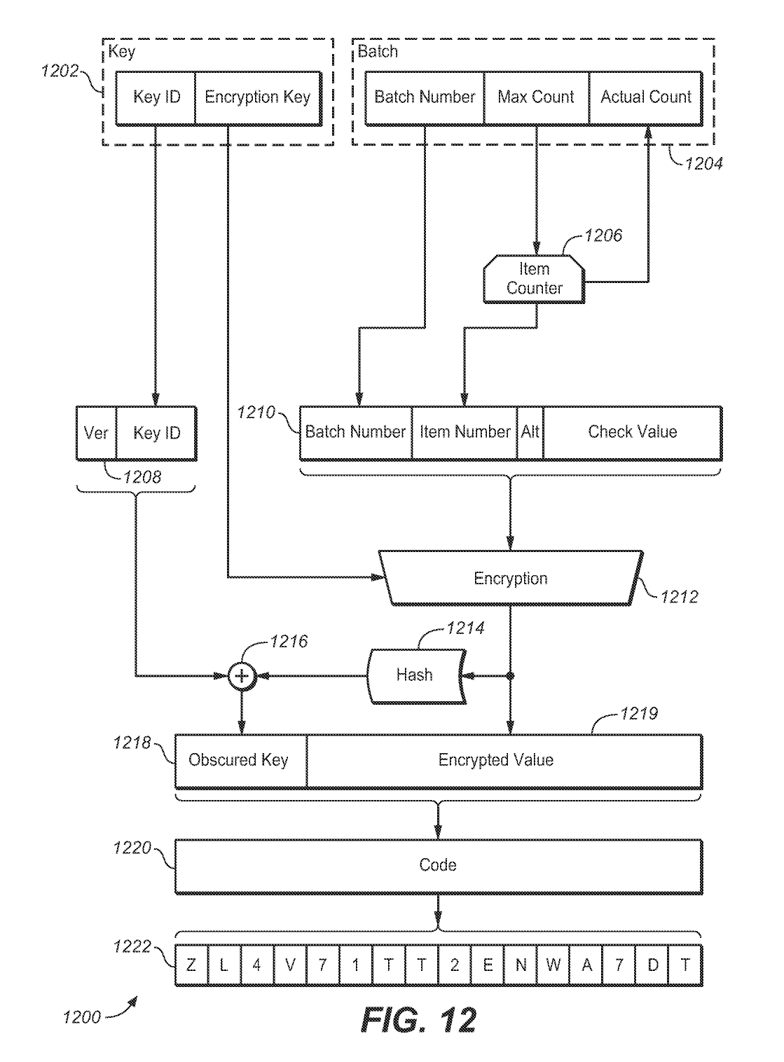

FIG. 12 is a block diagram illustrating a process 1200 of code generation and encryption, according to one embodiment.

When a request for a batch of codes is received, key information 1202 and batch information 1204 can be generated based on the client request. If the client is new, new key information and new batch information may be created based on coding needs of the new client. If the request is made by an existing client, existing key information 1202 and batch information 1204 may be retrieved and adjusted based on specific needs of the client (e.g., specific product line, specific manufacturing lot, specific version of an existing product, etc.).

In one embodiment, the key information includes a key-ID that identifies an encryption key and each client has a unique encryption key. In one embodiment, the key-ID is not maintained confidential since only the entity providing code generation services (e.g., server module 100) has access to the database linking the key-IDs to corresponding encryption keys.

In another embodiment, the same encryption key is used for each client. As such, the key information does not need to include the key-ID to identify an encryption key for a client since one encryption key is used for every client. Additionally, the batch numbers used for each client may be different (e.g., batches 1-5 for client A, and batches 10-15 for client B) so as to prevent same codes being generated for different clients.

In another embodiment, a predetermined number of encryption keys are used for a set of clients. The predetermined number of encryption keys used may be smaller than the number of clients. Rather than using a key-ID to identify an encryption key used, upon a request to authenticate a code, each of the encryption keys is used in an attempt to decode the code. If none of the decrypted values decrypted from each of the encryption keys yield the expected check value, then the code can be determined to be inauthentic. The decryption stops when one of the encryption codes is able decrypt a code to yield the expected check value or when the all the encryption codes have been used.

In one embodiment, the batch information 1204 may include a batch number, a maximum count of items, and an actual count of codes generated. The batch number and maximum count may be based on information sent by the client regarding their specific coding needs. The coding needs may be different for each product, each manufacturing site, each production date, etc. For example, a different batch number may be assigned for the same product but manufactured on different dates. The maximum count may be specified during the request based on the number of items that need coding. In one embodiment, the item counter 1206 sequentially generates an item number for each unit item and the number of actual codes generated (which may be less than the maximum count) is stored into the batch information 1204 as the actual count.

In one embodiment, a series of identifiers 1210 are combined where the series of identifiers include the batch number, the item number, an alternative value, and a check value. The check value is typically a known value that is predetermined and constant relative to a batch. In one embodiment, the series of identifiers 1210 is encrypted using an encryption algorithm (e.g., triple-key DES encryption) with the encryption key stored as the key information 1202. The encrypted value is shown as 1219. In one embodiment, the encrypting includes encrypting with multiple keys where the key includes multiple keys.

In another embodiment, to be able to authenticate the code, information about the key-ID is included in the code. For example, information about the key-ID may be included in the code using at least a portion of the encrypted code with the key-ID to generate an obscured key-ID to be included in the code. Using the at least a portion of the encrypted code may include computing a hash of the at least a portion of the encrypted code. In one embodiment, an obscured key-ID can be generated by performing an operation 1216 (e.g., a boolean operation, an arithmetic operation and/or a binary operation, etc.) between the key-ID and a hash (e.g., 16 bit hash) of the encrypted value 1219.

The obscured key-ID can then be combined with the encrypted value 1219 to form a code 1220. In one embodiment, the code 1220 has 80 bits where 16 bits include information about the key-ID and 64 bits include the encrypted value 1219. The code 1220 may be separated into smaller blocks (e.g., nibbles of 5 bits) and each block is converted into an alphanumeric character for readability. In one embodiment, each nibble of 5 bits is converted to numbers or digits, such as the alphanumeric representation 1222 based on a mapping process illustrated in Table 1 of FIG. 14.

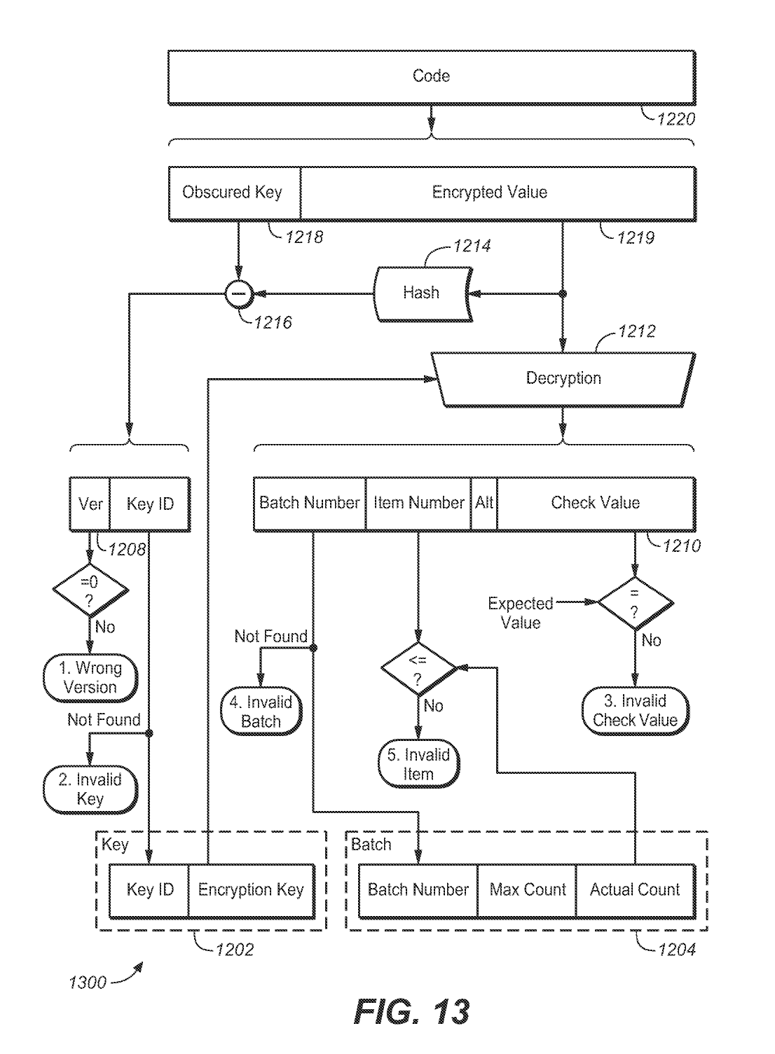

FIG. 13 is a block diagram illustrating a process 1300 of code verification, according to one embodiment.

When a code verification request is received, the alphanumeric representation of the code is first converted to its corresponding binary representation 1220 based on a mapping process illustrated in Table 1 of FIG. 14. Depending on how the alphanumeric representation was marked on a unit item, space characters and/or dashes in the alphanumeric representation may be removed prior to the conversion. In one embodiment, if the binary representation 1220 converted from the alphanumeric representation 1222 includes values that are not present in Table 1 of FIG. 14, the code is determined to be invalid. In one embodiment, if the number of characters of the alphanumeric representation received in the request is different from the expected number of characters, the code is determined to be invalid.

If all received characters are valid and the expected number of codes were received, the obscured key-ID and version indicator can be un-obscured through performing the function 1216 (e.g., boolean, arithmetic, and/or binary, etc.) on the obscured value with the hash 1214 of the encrypted value. In one embodiment, the recovered value 1208 includes a version indicator followed by the key-ID. In one embodiment, the obscured value 1218 is the first 16 bits of the code 1220 and the encrypted value is the latter 64 bits 1219 of the code 1220.

After the key-ID and the version indicator have been identified, the encryption key associated with the key-ID can be identified in a database (e.g., database 732 of the server module 100) of the coding service provider. In one embodiment, if a corresponding encryption key cannot be identified, the code is determined to be invalid. Since the key-ID was assigned through the coding service provider to clients, the coding service provider should have a record of key-IDs extracted from valid codes.

In one embodiment, if the encryption key corresponding to the key-ID is identified, the encrypted value 1219 (e.g., the latter 64 bits of the code 1220) is decrypted using the encryption key of the key information 1202. In one embodiment, a check value can be extracted from the decrypted block 1212 and compared to the expected value of the check value. If the extracted check value does not match the expected value, the code is determined to be invalid.

In one embodiment, a key-ID is not included in the code to identify an encryption key for the code. Rather, the same encryption key is used for each client. In another embodiment, a set of encryption keys is used. Rather than using a key-ID to identify the encryption key used to encrypt a particular code, each of the set of encryption keys is used to attempt to decrypt a code until the expected check value is extracted from the code. If none of the encryption keys can decrypt the code to yield an expected check value, the code can be determined to be inauthentic.

In addition, the batch number can also be extracted from the decrypted block 1210 to locate batch information 1204 that is associated with a particular product, manufacture lot, packaging site, etc. of the client. In one embodiment, if the batch number cannot be identified from the decrypted block 1210, the code is determined to be invalid. Furthermore, the item number can also be extracted from the decrypted block 1210. Since the batch information 1204 includes a count of the number of codes generated for a particular batch of items, the code is also determined to be invalid if the item number equals or exceeds the actual item count indicating tamper of the code production process to generate more codes than authorized.

FIG. 14 is an example conversion table for mapping encrypted product codes into an alphanumeric representation, according to one embodiment.

In one embodiment, the final product code of binary representation may be divided into smaller sized blocks (e.g., 16 of 5 bit nibbles) where each block is converted to an alphanumeric character to enhance readability and/or to minimize space required to mark a product code on a product packaging. In one embodiment, the conversion module 746 of the server module 100 of FIG. 2 reference the conversion table stored in the database 202 to perform the alphanumeric conversion. In one embodiment, each of the 5-bit nibbles is converted to one of 32 alphanumeric characters shown in Table 1 including ten digits and 22 upper case ASCII letters. The letters O, Q, B, and I are not used due to potential confusion with the digits 0, 1, and 8. During verification, the conversion module 746 may also reference Table 1 to map the alphanumeric representation of a product code received from a client back to the binary representation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

1. A method comprising:
generating a plurality of uniform resource locators (URLs), each URL being unique for each item of a set of items, each URL to provide access to the product information associated with each item; and
providing the plurality of URLs to be separately marked on the set of items.

2. The method of claim 1 wherein at least a portion of the plurality of URLs includes a unique identifier for the item.

3. The method of claim 1 further comprising receiving a request to generate the plurality of URLs, each URL to be placed on each item of the set of items.

4. The method of claim 1 further comprising recording and maintaining the product information of each item associated with at least a portion of the plurality of URLs.

5. The method of claim 1 wherein the product information comprises security features of the item including at least one of a package image of the item, a hologram, color-shifting ink, and micro-texts.

6. The method of claim 1 wherein the product information comprises at least one of an expiration date, a manufacturing information, a pre-identified destination of the item, and a universal product code (UPC).

7. The method of claim 2 wherein the providing the at least a portion of the product information comprises determining authenticity of the item by authenticating at least a portion of the associated URL.

8. The method of claim 2 wherein the providing the at least a portion of the product information further comprises detecting counterfeit products by counting a number of instances a same URL has been accessed.

9. The method of claim 2 wherein the providing the at least a portion of the product information further comprises detecting diversion of products by comparing the pre-identified destination of the item and a location data of authentication of the item.

10. The method of claim 1 further comprising marking the item with an identifier of the associated URL of the item.

11. The method of claim 5 wherein the identifier of the URL is represented by a bar code.

12. The method of claim 5 wherein the bar code is scannable by an image capturing device.

13. The method of claim 6 wherein the image capturing device is an electronic device that is at least one of a mobile phone, a digital camera, a laptop computer, a PDA, a desktop computer, a scanner, or a camera.

14. The method of claim 5 wherein the bar code is a 2D bar code.

15. The method of claim 8 wherein the 2D bar code is a QR code.

16. The method of claim 9 wherein the 2D bar code is a data matrix.

17. A machine readable media having stored thereon a set of instructions, which when executed cause a machine to perform a method comprising:
generating a plurality of uniform resource locators (URLs), each URL being unique for each item of a set of items, each URL to provide access to the product information associated with each item; and
providing the plurality of URLs to be separately marked on the set of items.

18. A system, comprising:
a means for, generating a plurality of uniform resource locators (URLs), each URL being unique for each item of a set of items, each URL to provide access to the product information associated with each item; and
a means for, providing the plurality of URLs to be separately marked on the set of items.
